(19) United States
(12) Patent Application Publication
(10) Pub. No.: US 2007/0042933 A1
(43) Pub. Date: Feb. 22, 2007

(54) Fragrances, cosmetics and other body products based on Phi

(76) Inventor: Michelle V. Roark, Denver, CO (US)

Correspondence Address: LEYENDECKER LEMIRE & DALEY, LLC, C/O PORTFOLIO IP, P.O. BOX 52050, MINNEAPOLIS, MN, 55402, US

(21) Appl. No.: 11/204,622

(22) Filed: Aug. 16, 2005

(51) Int. Cl. A61Q 13/00

(52) U.S. Cl. 512/1

(57) ABSTRACT

In embodiments of the present invention, body products, and fragrances in particular, are described that comprise a plurality of ingredients combined in proportions based on one or more of Phi (1.618 . . . ), phi (1/Phi), and the Fibonacci series.

### FIELD OF THE INVENTION

The present invention relates generally to fragrances and cosmetics and other body products.

### BACKGROUND

Phi has been referred to as the “Divine Proportion”, the “Golden Number”, the “Golden Ratio”, the “Golden Mean”, and the “Golden Section”. Many consider Phi to be the most perfect number.

Phi, “Φ”, is an irrational number that can be derived from the ratios of line segments that are divided in a specific manner. Specifically and referring to FIG. 1, any line 10 can be divided at point M in such a manner that the ratio of the length of the line A to the longer segment B is the same as the ratio of the longer segment B to the shorter segment C. This ratio, or Phi, is the irrational number 1.6180339887 . . . . Further, the reciprocal of Phi is known as phi with a lower case “phi” or 0.6180339887 and is equal to the ratio of the longer segment B to the length of the line A which is the same as the ratio of the shorter segment C to the longer segment B. Interestingly, little phi is also Phi minus one.

The Divine Proportions of Phi can be found in a numerical series referred to as the Fibonacci sequence (or series) wherein each number after the second is the sum of the two preceding sums: 1, 1+1=2, 1+2=3, 2+3=5, etc. When dividing the present sum by the preceding sum, one gets a ratio that isolates around Phi. The ratios converge as the series progresses becoming ever closer to Phi.

The Fibonacci sequence (The Divine Proportions of Phi) and (the number) Phi appear throughout life in many biological systems such as human anatomy, strands of DNA, nautilus shells, spiral galaxies, plants and flowers as is discussed in detail at www.goldennumber.net. Select pages from the website are attached hereto as Appendix A and are otherwise fully incorporated by reference. Simply, the existence of Phi and its' Divine Proportions, the Fibonacci series, in nature is so prevalent and pervasive that one might reasonably conclude its presence is not random. In other words, it is reasonable to conclude Phi and the Fibonacci series have some divine significance.

Phi and the Fibonacci series also appear prevalently in architecture, art and music as is also discussed at www.goldennumber.net and on select pages provided in Appendix A. For instance, the pyramids utilize Phi in their geometry. The Parthenon's dimensions are in the form of a golden rectangle wherein the ratio of the long side to the short side is Phi. Additionally, Renaissance architects used the Phi ratio in their creations, such as Notre Dame in Paris. In some of the architectural creations, the designers may have made a conscience choice to use Phi ratios but in others, such as the Pyramids there is no evidence that the architects actually recognized Phi or its mathematical significance. Artists, such as Leonardo DaVinci, French Impressionist painter Georges Pierre Seurat and Salvador Dali all used Phi in laying out and framing their paintings. Further, musical scales and western musical frequencies are based on Phi and the Fibonacci series.

Collectively, it appears that many in the various arts have recognized that Phi based constructions of audible and visual works are pleasing and stimulating to people's senses of hearing and vision. In other instances, it appears that some artists and architects tend to formulate their creations unknowingly around Phi. Simply, there is something about this number that draws people to it. Perhaps, it has to do with the divine nature of the ratios and the human connection to the divine. Or perhaps, Phi has some undiscovered significance in physics that dictates how nature is constructed, and accordingly, how living things, such as humans, are drawn to Phi.

### BRIEF DESCRIPTION OF THE DRAWINGS

FIG. 1 is a depiction of the Phi line, a divided line in which dividing the length of the line by the length of the longer segment results in a ratio of Phi.

FIG. 2 is a table listing the components in an exemplary perfume according to a first embodiment of the present invention.

FIG. 3 is a table listing the components in an exemplary cologne according to a second embodiment of the present invention.

FIG. 4 is a table listing the components in an exemplary fragrance according to a third embodiment of the present invention.

FIG. 5 is a table listing the components in an exemplary lipstick according to a fourth embodiment of the present invention.

FIG. 6 is a table listing the components in an exemplary perfume according to a fifth embodiment of the present invention.

FIG. 7 is a table listing the components in an exemplary perfume according to a sixth embodiment of the present invention.

FIG. 8 is a table listing the components in an exemplary lotion according to a seventh embodiment of the present invention.

### DETAILED DESCRIPTION

Embodiments of the present invention include fragrances and perfumes comprised of ingredients mixed in Phi-based proportions. It is theorized that such a unique combination may more effectively and pleasingly stimulate a person's sense of smell than non-Phi based creations in a manner similar to that in which Phi-based art and musical creations can stimulate a person's senses of sight and hearing respectively.

In one embodiment, each ingredient in the fragrance is present in the fragrance in integer units of measure wherein the integer is a number from the Fibonacci series. Further, the total number of ingredients can be a number in the Fibonacci series. In another embodiment, each ingredient may be mixed with other ingredients wherein the ratio of the amounts of any two ingredients is Phi, phi or an integer proportion of Phi or phi. Other manners of combining the components in a fragrance are also contemplated so long as the combination is based on Phi, phi or the Fibonacci series.

Other embodiments of the present invention comprise cosmetics and other body products, such as but not limited to lipstick, makeup, lotion, shampoo and conditioners. The components included in the cosmetics and/or body products are combined or mixed based on Phi, phi and/or the Fibonacci series in a similar manner(s) as the fragrances. It is theorized that such a unique combination may more effectively and pleasingly stimulate a person's sense of smell as well as sight and touch than non-Phi based creations also in a manner similar to that in which Phi-based art and musical creations can stimulate a person's senses of sight and hearing respectively.

Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “embodiments”, “variations”, “a variation” and similar phrases means that a particular feature, structure, or characteristic described in connection with the embodiment(s) or variation(s) is included in at least an embodiment or variation of the invention. The appearances of the phrase “in one embodiment” or “in one variation” in various places in the specification are not necessarily all referring to the same embodiment or variation.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

The term “fragrance” as used herein unless clearly and specifically indicated otherwise refers to any products, liquid or solid based that are provided primarily or substantially for their fragrance. These products include, but are not limited to: perfumes (solids and liquids), bath fragrances, colognes, Eau De Toilettes, body sprays and splashes, candle fragrance, aroma therapy products and/or oils, and fragranced powers. “Perfume” is a highly concentrated fragrance containing between 20-50% or more of a perfume essence, wherein the essence comprises the top, middle, and bottom notes of the perfume.

The term “ingredients” as used herein typically refers to the raw materials or basic elements of a body product mixture. The term “carrier base” as used herein refers to an ingredient of the body product mixture that is typically utilized to dilute a concentrate making the resulting product more suitable for its intended use. Although the “carrier base” is technically an “ingredient”, as used in several of the claims, it is recited as being distinct from the “ingredients”.

As used herein the term “cosmetics” refers to any topical preparation used to alter or enhance a person's appearance. Cosmetics include, but are not limited to, lipstick, eye shadow, foundation, cover, eye makeup, blush and makeup generally.

As used herein the phrase, “body products” refers to any solid or liquid formulations that are applied externally to a person to clean, refresh, condition, moisturize, adorn and/or impart a fragrance to the person. Cosmetics and fragrances are considered subclasses of body products for the purposes of this disclosure. Some other body products include, but are not limited to, shampoos, conditioners, moisturizers, lotions, body washes, body powders and soaps.

### A FIRST EMBODIMENT OF A PERFUME

Typically, fragrances in general and perfumes in particular, are combinations of various essences and fixations combined in a base. The essences are classified based on their volatility as top (or head), middle (or heart) and bottom (or base) notes. The volatility measurement relates to how long any particular ingredient will remain perceptible to one or both of the wearer of the fragrance or someone else within proximity of the wearer. A typical perfume will include a combination of essences from all three classifications to create a balanced product.

Bottom or base notes are intense and profound, and evolve over the course of hours or even days. Relatively speaking, they have low volatility. They are often thick and/or syrupy. They may be derived from: bark, such a sandalwood; roots, such as angelica; resins, such as labdanum; lichens, such as oakmoss; saps, such as benzoin and peru balsam; and animal products, such as the musk from the musk deer. Because they are so intense and tend to linger the longest, they are typically, although not necessarily, found in lower relative concentrations in a perfume than heart and head notes.

Middle or heart notes impart body to perfume blends by providing warmth and fullness. Often they compliment other notes by accentuating or bringing out their best. They are typically heady, dramatic and intense, and alone some can even be sickly sweet. They have moderate volatility lasting longer than head notes but not as long as base notes. Heart notes usually consist of florals and some spices. They are often used in moderate concentrations in a perfume.

Top or head notes are the most volatile, and accordingly, they will be perceived first often providing a perfume's initial impression. Given their relatively high volatility, they dissipate quickly and do not linger. Many head notes are used in food preparation. They include various herbs and species, such as coriander, spearmint, black pepper, cardamom, juniper, basil and tarragon. They also include various citruses, such as lime, bitter orange, blood orange, lemon, tangerine and pink grapefruit. Given their high volatility, head notes are typically present in a perfume in the highest relative concentrations.

A perfume will include one or more fixations that act as a preservative to prevent the premature dissipation of the various essences when the perfume is in its bottle or after the fragrance has been applied to a person. Additionally, a fixation will act to hold the composition of the perfume together. Typical fixations include coconut oil (increases shelf life, odorless, absorbs readily into the skin helping the fragrance to last longer, thins out the mixture so it will spray through a pump sprayer with ease), vitamin E (is a preservative), and Isopropyl Myristate (helps hold the fragrance together, prevents solidification of an essence in the perfume). The combination of essences and the fixation agent comprise the perfume concentrate.

Finally, a perfume also includes a carrier base. The carrier base acts to dilute the perfume concentrate to a level that permits a wearer to apply the perfume with minimal difficulty. As can be imagined, it would be very difficult to apply just the right amount of perfume in instances where the ideal amount is well less than a drop as dispensing less than a drop of any liquid can be difficult.

Prior art perfumes often use an ethyl alcohol carrier base, but alcohol carrier bases can be problematic. For one, alcohol has a distinct albeit generally faint order that can hinder, modify or even destroy the fragrance of the essences. Alcohol is also a drying agent that can dry a wearer's skin as it evaporates. Additionally, as alcohol evaporates it can take some of the perfume's essences away, thereby affecting the smell and longevity of the perfume on the wearer and in the bottle.

In at least one embodiment of the present invention, a carrier base of jojoba oil is utilized. Jojoba oil moisturizes the skin instead drying it out. Since jojoba oil has low rate of evaporation on the skin, it permits the essences and notes contained in it to fully develop without being prematurely dissipated through evaporation. Further, since the oil does not evaporate as it is being applied, jojoba oil permits a wearer to better control the perfume's application on the wearer's skin to gain a more even distribution. Jojoba oil also acts as a fixation agent for the essences, and is known for its antibacterial and preservative properties, which helps prolong self life. Additionally, and perhaps most importantly, jojoba oil is odorless, so it does not effect the development and smell of an associated perfume or fragrance.

Many of the essences of the first embodiment perfume are obtained from plant matter through expression or distillation. Expression is the process of squeezing the oil and associated juice out of the plant matter and subsequently separating the oil from the juice. Expression is most often utilized with fruit.

Distillation is more typically utilized with leaves, flowers, wood, grasses and other non-fruit plant matter. First, the plant matter is arranged in a receptacle, referred to as a still, and steam is passed through the plant matter. The volatile chemicals that make up the essential oil in the plant matter are vaporized and carried away in the steam. The steam is then condensed in a condenser and since the oil and the water do not mix and oil is typically lighter than water, the oils are skimmed off the top of the condensate. It is appreciated that the exact parameters of the distillation process will vary depending on the specific type of plant matter being distilled as would be obvious to one of ordinary skill in the art.

Other essences of the first embodiment perfume are animal products. Animal secretions or glands are steeped in alcohol producing a tincture. A dark colored absolute is then obtained by removing the alcohol. All essential oils, extracts, and absolutes are 100% pure within a certain margin of impurities weather distilled, expressed, extracted, or tinctured.

Essences can also be extracted from desired plant matter using solvents, such as hexane and petroleum ether, to dissolve the oil, wax and color in the plant matter. The solvents are then evaporated off to produce a “concrete”. Any waxes in the concrete can then be removed to create an “absolute”. In the first embodiment, none of the essences are extracted using solvents while certain essences may be in variations and alternative embodiments. It is appreciated that whenever possible essences obtained through distillation and or expression are preferred although not necessarily required.

Additionally, essences can be synthetically created to imitate a natural scent. Synthetics may be derived or isolated from natural products or completely manufactured in the laboratory. Some synthetics are superior to natural essences in uniformity and stability. Further, for some essences, they are more readily available and much more cost effective than natural essences. In the first embodiment, only Lily of the Valley is a synthetic as a natural product is not easily available. One brand of synthetic Lily of the Valley is Lyral® produced by International Flavors and Fragrances, Inc. of New York, N.Y.

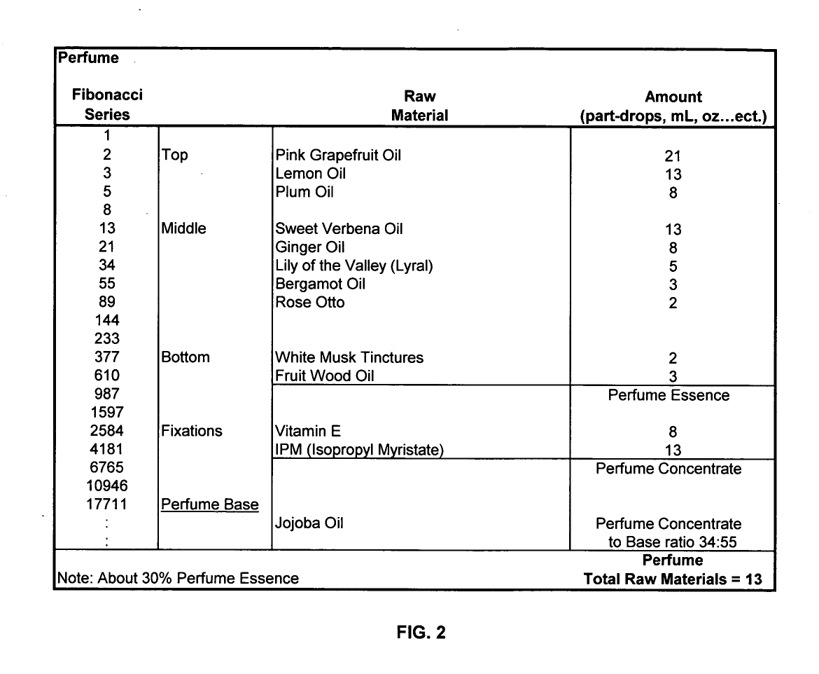

Referring to FIG. 2, the composition of the first embodiment perfume is provided. The first embodiment is merely exemplary and not intended to be limiting. As can be readily observed, all the ingredients are provided in relative amounts that relate to integer numbers in the Fibonacci series. It is appreciated that the units used to measure the relative amounts is not important so long as the same unit measure is used for all ingredients in a particular mixture. The measure may be volumetric or mass-based. For instance, the units can be, but are not limited to: part-drops, ounces, milliliters, and grams. In the first embodiment, the units of measure are intended to be volumetric.

In the first embodiment, the perfume essence is comprised of the top or head notes, the middle or heart notes, and the bottom or base notes. The top notes are: 21 units of pink grapefruit oil; 13 units of lemon oil; and 8 units of plum oil. The middle notes are: 13 units sweet verbena oil; 8 units of ginger oil; 5 units of Lily of the Valley; 3 units of bergamot oil; and 2 units of Rose Otto. The bottom notes are: 2 units white musk absolute; and 3 units of fruit wood oil. Fixations of vitamin E and isopropyl Myristate are combined to provide the perfume concentrate in 8 and 13 units of measure respectively.

As mentioned above, each unit number is an integer number in the Fibonancci series. However, it is appreciated that during manufacture of the perfume some variance in the measurement of the ingredients is to be practically and reasonably expected. Small variations will have minimal effect on the resulting perfume, but large variations can negatively impact any resulting smell. Accordingly, a tolerance of less than 20% is preferred, a tolerance of less than 10% is more preferred, and a tolerance of less than 5% is most preferred concerning the measurement or ratio of any ingredient or carrier base in the perfume.

The perfume concentrate of the first embodiment is mixed with the perfume base of jojoba oil in a ratio of 34 units of perfume concentrate to 55 units of base. The ratio of concentrate to base comprises two consecutive numbers of the Fibonacci series, and accordingly, the ratio approximates phi out three decimal places. Or, if expressed as the ratio of base to perfume concentrate the ratio is approximates Phi out three decimal places.

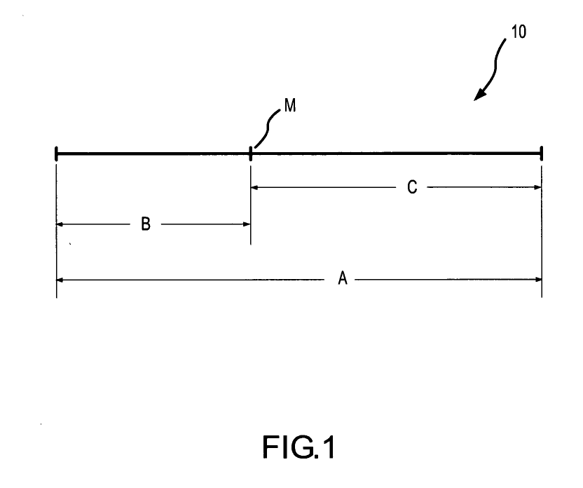

As also indicated in FIG. 1, the total number of ingredients in the first embodiment perfume is thirteen, which is also a number in the Fibonacci series. Accordingly, the first embodiment perfume relates to Phi in at least three ways: (i) all ingredients are present in Fibonacci series integer unit multiples; (ii) The ratio of the perfume base to perfume concentrate is Phi; and (iii) the number of ingredients in the perfume is a Fibonacci series integer.

### A SECOND EMBODIMENT OF A COLOGNE

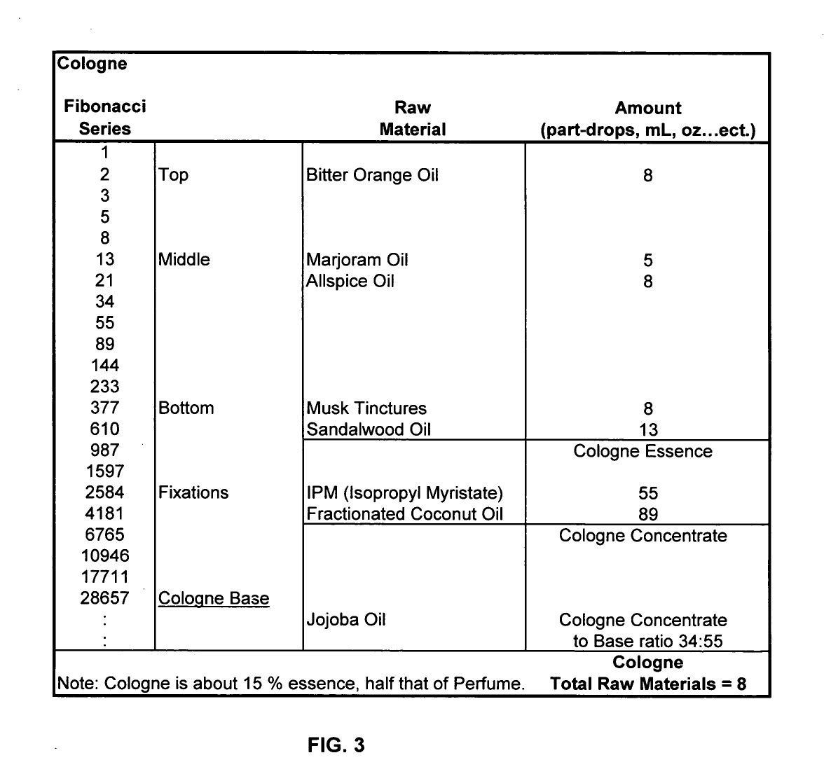

FIG. 3 lists the various concentrations of ingredients of a men's cologne based on Phi and the Fibonacci series. Prior art men's colognes are typically much less concentrated than perfumes containing only about 5-15% of essences compared to 20-50% for perfumes. Prior art men's aftershaves will typically have a concentration of about 3-5% essences and women's colognes will have about a 3% concentration of essences. There are no hard and fast rules concerning the amount or concentration of essences in a cologne and the actual percentage can be much higher. It is appreciated that with higher concentrations of essences, the amount a user would apply to himself is reduced accordingly.

In the second embodiment, the cologne includes 8 units of bitter orange oil as a head or top note. 5 units of marjoram oil and 8 units of allspice oil are provided as middle or heart notes. 8 units of musk absolute and 13 units of sandalwood oil are provided as bottom or base notes. This makes up the cologne essence. As with the perfume above, all unit numbers are also Fibonacci series numbers.

Observation indicates that the base notes are in the greatest concentration followed by heart notes with head notes comprising the lowest concentration. This is generally opposite the relative note concentrations of perfumes, such as the first embodiment. It is appreciated that this is due in part to the difference between a men's fragrance and a women's fragrance, but it should be understood that the concentrations of the various notes relative to each other can vary significantly and substantially depending on the type of fragrance as well as the desires of the fragrance designer.

Fixations of 55 units isopropyl myristate and 89 units fractionated coconut oil are mixed with the essences to form the cologne concentrate. The concentrate is then mixed with jojoba oil in a relative ratio of 34:55, which as indicated above approximates phi out to three decimal places as both “34” and “55” are Fibonacci series numbers. As can be appreciated, a designer can further reduce the percentage concentration of essence in the cologne by using other ratios of Fibonacci series numbers. For example, if the ratio of 21:89 of concentrate to base were utilized, the percentage of essences in the final product would be about 7%. The men's cologne of FIG. 2 does not use alcohol and as such does not act to dry or otherwise irritate the skin; however, other embodiment colognes can be produced using more conventional bases, such as alcohol, while still applying the Phi based principles concerning ingredient proportions.

As also indicated in FIG. 3, the total number of ingredients in the second embodiment cologne is eight, which is also a number in the Fibonacci series. Accordingly, the second embodiment cologne relates to Phi in at least the same three ways as the first embodiment perfume: (i) all ingredients are present in Fibonacci series integer unit multiples; (ii) The ratio of the cologne carrier base to cologne concentrate is Phi; and (iii) the number of ingredients in the cologne is a Fibonacci series integer.

### A THIRD EMBODIMENT OF A FRAGRANCE

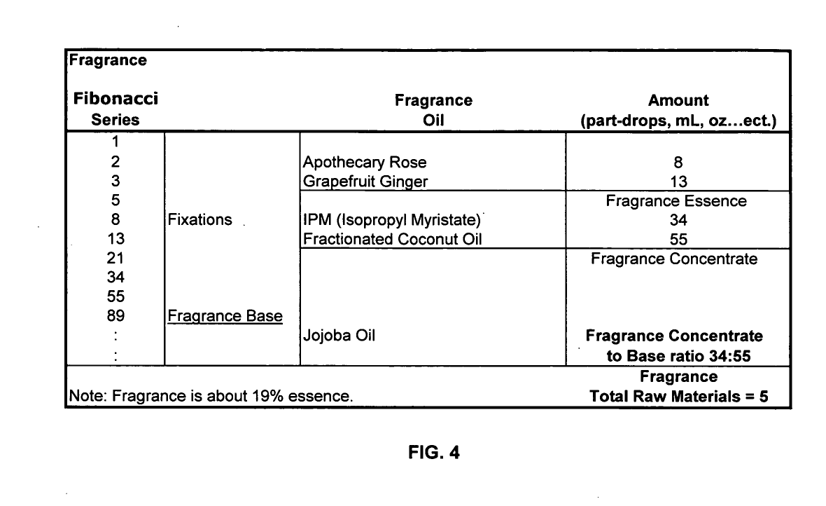

The third embodiment of FIG. 4 comprises a general fragrance that is often used for scenting various products, such as candles, potpourri, lotions and soaps. The number of distinct essences found in simple fragrances can be low compared to perfumes and colognes often because the desired scent to be imparted to a corresponding product is intended to be very simple or even singular. For example, a fragrance that is intended to impart a primarily lavender odor to a lotion will comprise a lavender oil essence and may be one or two more essences that compliment and accentuate the lavender odor but not any more.

The exemplary fragrance of FIG. 4 comprises: a concentrate of 8 units of apothecary rose and 13 units of grapefruit ginger fixed with 34 units of Isopropyl Myristate and 55 units of fractionated coconut oil; and a base of jojoba oil. The concentrate and base are mixed in a 34:55 ratio. A total of 5 ingredients comprise the fragrance.

Like the first and second embodiments, the third embodiment relates to Phi in at least three ways: (i) all ingredients are present in Fibonacci series integer unit multiples; (ii) The ratio of the carrier base to fragrance concentrate is Phi; and (iii) the number of ingredients in the fragrance is a Fibonacci series integer.

### A FOURTH EMBODIMENT OF A LIPSTICK

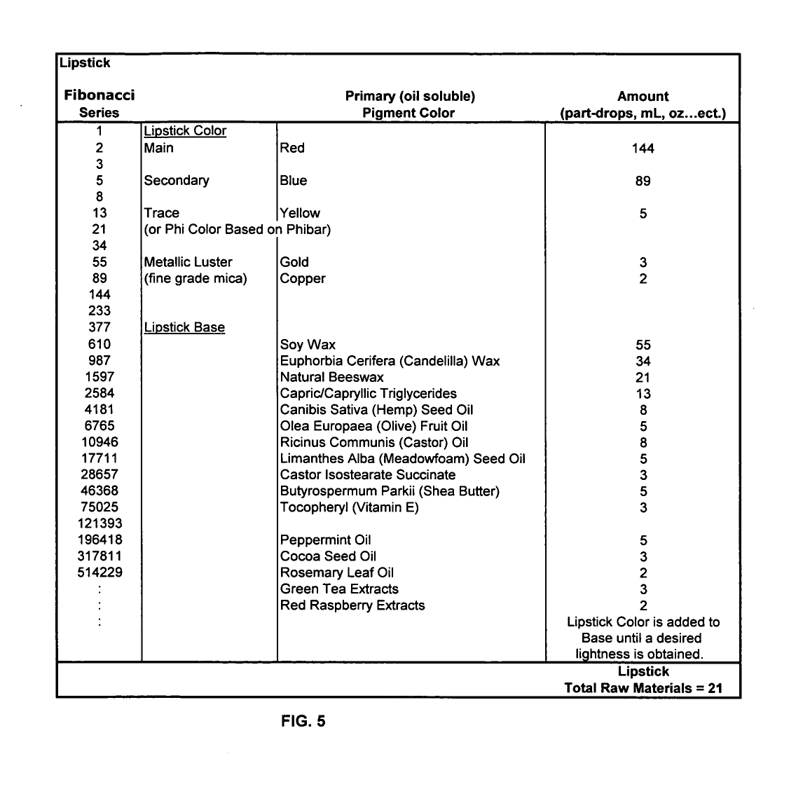

The first three embodiments relate primarily to the odor or scent produced by a fragrance combined in a manner and proportions related to Phi and/or the Fibonacci series. It is appreciated that the same or similar methodologies can be applied to body products other than those dictated primarily by scent. For example, the fourth embodiment of FIG. 5 is a mixture for producing a lipstick. Lipsticks do not generally impart any specific odor or fragrance, although they may be designed to be pleasing to the olfactory nerve. Rather, one of the key considerations in a lipstick is the particular lipstick's color and how visually pleasing it is.

As shown in FIG. 5, the lipstick color is comprised of five (a Fibonacci number) base colors: red; blue; yellow; gold and copper (actually fine grade mica). Each is present in discrete integer unit amounts wherein each integer is a number in the Fibonacci series. Specifically, 144 units of red Lake Set pigment; 89 units of blue Lake Set pigment; 5 units of yellow Lake Set pigment; 3 units of metallic luster gold fine grade mica pigment; and 2 units of metallic luster copper fine grade mica pigment are combined to make the lipstick color concentrate.

In variations, the main, secondary and trace colors can be chosen by applying a concept referred to as the PhiBar. The PhiBar concept was introduced by Michael Semprevivo and uses the wave lengths of light in the visible spectrum to determine a third color when two initial colors are chosen. The PhiBar concept is explained in greater detail at www.goldennumber.net, which is incorporated herein by reference and select pages thereof are included as Appendix A. Simply, a person chooses a first color and a second color. The wavelength difference between the two colors is designated as phi and the third color is the color located the distance Phi minus phi (or one) from the second color. Usually, this concept is used to create pleasing color combinations; however, it can also be applied to create color mixes that are visually pleasing. After choosing the colors, the proportions in which they are mixed can be dictated by Phi and/or the Fibonacci series.

Once the lipstick color is produced, it is added to a lipstick base until the desired level of lightness or darkness is obtained. In preferred variations, the lipstick base comprises ingredients combined in Fibonacci and/or Phi based proportions. For instance, the base of FIG. 5 comprises: 55 units of soy wax; 34 units of euphoria cerifera wax, 21 units of natural beeswax; 13 units of capric/capryllic triglycerides; eight units of canibis sativa seed oil; 5 units of olea europaea fruit oil; 8 units of ricinus communis oil; 5 units of limanthes alba seed oil; 3 units of castor isostearate succinate; 5 units of butyrospermum parkii; 3 units of tocopheryl; 5 units of peppermint oil; 3 units of cocoa seed oil; 2 units of rosemary leaf oil; 3 units of green tea extracts; and 2 units of red raspberry extracts.

The lipstick of FIG. 5 has a total of 21 ingredients, wherein 21 is a number in the Fibonacci series. Accordingly, the lipstick also relates to Phi in at least two ways: (i) all ingredients are present in Fibonacci series integer unit multiples; and (ii) the number of ingredients in the lipstick is a Fibonacci series integer. In certain variations, the lipstick further relates to Phi in that the main, secondary and trace colors are all chosen based on the PhiBar concept.

### A FIFTH EMBODIMENT OF A LOTION

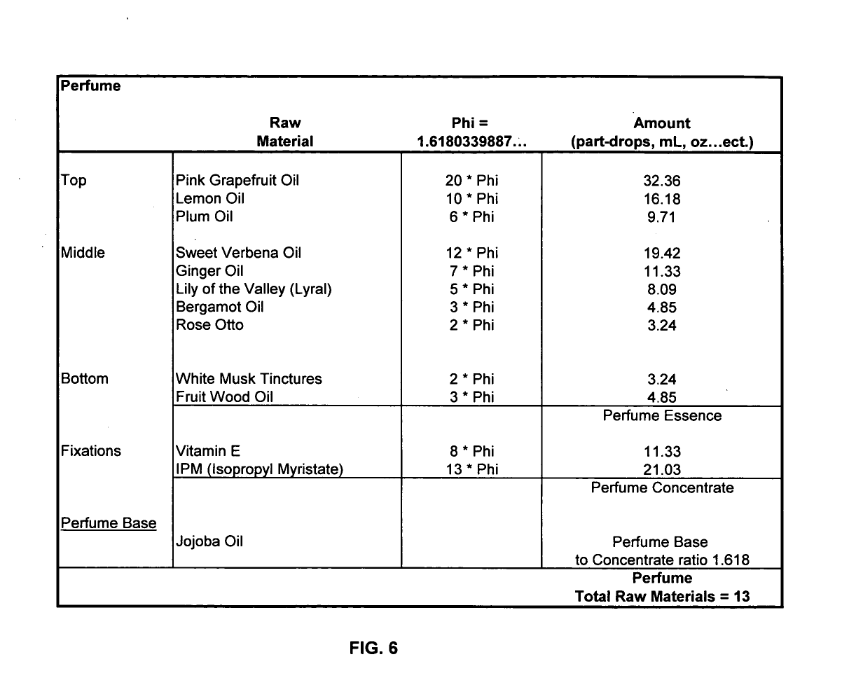

All previous embodiments are based primarily on combinations of ingredients in integer units wherein each integer is a number in the Fibonacci series. As described above, any one number in the series divided by a neighboring number in the series approximates Phi. In variations of the embodiments provided above, it is possible to combine ingredients in distinct integer multiples of Phi or phi wherein any one ingredient is present in a unit amount of a integer times Phi (or phi). The integer multiples need not comprise integer numbers in the Fibonacci series. For example in the case of a perfume as illustrated in FIG. 6, a first ingredient can be pink grape fruit oil present in 32.4 (20 times Phi) units and a second ingredient can be lemon oil present in 16.2 (10 times Phi) units.

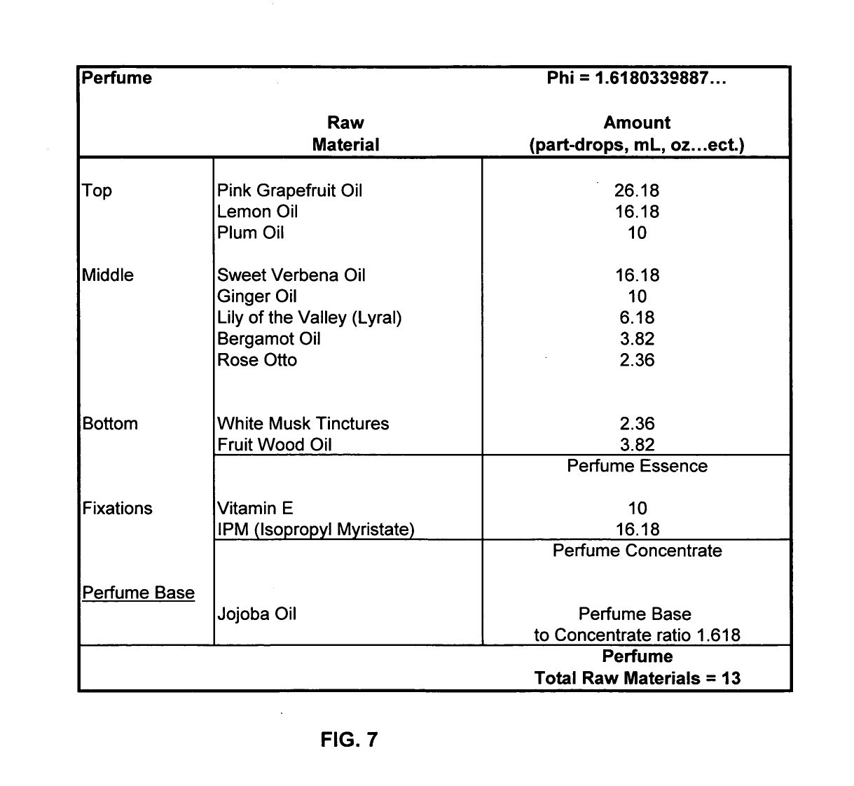

In yet another manner to combine ingredients using Phi, every ingredient (or a portion of ingredients therein) must be present in either the same or Phi-based (and/or phi-based) proportions relative to at least one other ingredient in the resulting product. For example in the case of a perfume generally similar to the first embodiment as shown in FIG. 7, 10 units of ginger oil may be present in the perfume concentrate with 16.18 units of sweet verbena oil (Phi times 10), and 6.18 units of Lyral (10 divided by Phi).

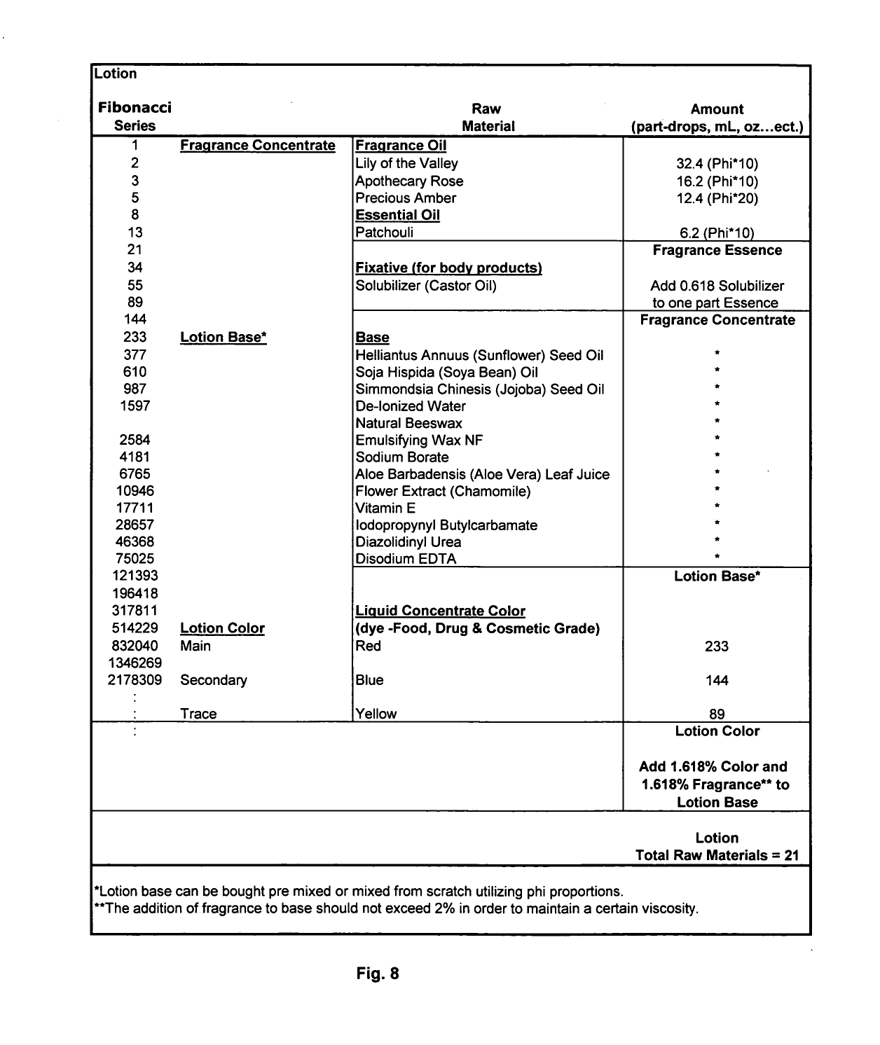

Further, any one cosmetic or body product formulation may utilize differing manners of combining and determining proportions of ingredients based on Phi as would be obvious to one of ordinary skill in the art given the benefit of this disclosure. The lotion of FIG. 8 comprises three main components: a fragrance concentrate; a lotion base; and a lotion color mixture. Each component is comprised of two or more ingredients.

The fragrance component of the FIG. 8 lotion is comprised of 32.4 units of Lyral, 16.2 units of Apothecary Rose, 12.4 units of Precious Amber and 6.2 units of patchouli oil. As is evident each of the unit multipliers is an integer multiple of Phi or phi. Alternatively, the fragrance essences could be mixed in proportions using one of the alternative manners of combining based on Phi. As shown, solubilizer or castor oil is added to the fragrance as a fixative in a ratio of phi (0.618 . . . ) relative to each part of the essence mixture.

The lotion base can be purchased premixed or it can be prepared from the ingredients listed using Phi-based proportions. Of particular note, the lotion demonstrates that in some embodiments and variations of body products not all ingredients or components of the product need be combined based on Phi, phi or the Fibonacci series, especially where the components do not relate to a particular property that may be enhanced by using Phi-based proportions. In the FIG. 8 lotion, the combination of ingredients in the lotion base is not adapted to affect the odor or color of the resulting lotion substantially, and accordingly, need not be Phi-based in all variations. In other variations, the ingredients of the lotion base may be Phi-based, and accordingly, may facilitate a lotion with superior tactile qualities. It is to be further appreciated that the manner in which one component is mixed or combined based on Phi need not be directly related to the manner in which another component is mixed or combined based on Phi.

The third component, the lotion color mixture, comprises a mixture of red, blue and yellow food, drug and cosmetic grade dye in unit amounts of 233, 144 and 89 respectively. The unit amount integers are all numbers in the Fibonacci series.

Each of the three components is combined with the other two using Phi-based proportions to create a resulting lotion. Namely, 1.618% of both the color mixture and the fragrance concentrate are added to the lotion base. It is appreciated that in variations, the amount of these two components added to the base may be in amounts that are integer multiples of 1.618%.

### ALTERNATIVE EMBODIMENTS AND OTHER VARIATIONS

The various preferred embodiments and variations thereof illustrated in the accompanying figures and/or described above are merely exemplary and are not meant to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

In one alternative embodiment of the present invention a packaged combination of cosmetics is comprised, such as an eye shadow grouping, wherein the colors provided in the combination are chosen by applying the aforementioned PhiBar concept. Accordingly, a wearer can be assured that the three (or more) colors in the combination are visually pleasing together.

I claim:

1. A body product comprising a combination of (i) a plurality of ingredients and (ii) a carrier base, wherein each ingredient of the plurality of ingredients is present in the body product in a unit amount multiplied by an integer of a plurality of integers, the plurality of integers comprising numbers in a Fibonacci series.

2. The body product of claim 1, wherein the body product is a fragrance.

3. The body product of claim 2, wherein the fragrance is a perfume.

4. The body product of claim 3, wherein the ingredients comprise at least one essence and at least one fixation.

5. The body product of claim 1, wherein the carrier base does not comprise alcohol.

6. The body product of claim 5, wherein the carrier base comprises jojoba oil.

7. The body product of claim 4, wherein substantially all of the essences are naturally-derived and not synthetic.

8. The body product of claim 1, wherein the units are volumetric units.

9. The body product of claim 1, wherein the units are mass units.

10. The body product of claim 1, wherein the carrier base is combined with the plurality of ingredients in a ratio of two numbers from the Fibonacci series.

11. The body product of claim 1, wherein a total number of the plurality of ingredients plus one or more base ingredients comprising the carrier base is a Fibonacci number.

12. A body product comprising a plurality of ingredients combined based on one or more of Phi, phi and a Fibonacci series.

13. The body product of claim 12, wherein the proportion of any ingredient relative to any other ingredient is (i) 1, (ii) Phi, (iii) phi or (iv) an integer multiple of Phi or phi.

14. The body product of claim 12, wherein the amount of each ingredient is a unit of measure multiplied by an integer of a plurality of integers, the plurality of integers comprised of numbers in the Fibonacci series, the unit of measure being a similar measure for all ingredients of the plurality of ingredients.

15. The body product of claim 12, wherein the body product comprises a cosmetic product.

16. The body product of claim 15, wherein the cosmetic product comprises lipstick.

17. The body product of claim 12, wherein the body product comprises a cologne having a carrier base, the carrier base comprising coconut oil.

18. A method of producing a body product, the method comprising:
selecting three or more ingredients; and
combining the three or more ingredients with each other in proportions based on one or more of Phi, phi and a Fibonacci series.

19. The method of claim 18, wherein the body product comprises a perfume and said selecting three or more ingredients further comprises selecting (i) one or more essences, (ii) one or more fixations, and a non-alcoholic carrier base.

20. The method of claim 19, wherein said combining three or more ingredients includes (a) combining each of the one or more essences and one or more fixations with each other in discreet integer unit amounts top create a concentrate, each integer unit amount comprising a number of the Fibonacci series, and (b) combining the concentrate with the non-alcoholic carrier base in a Phi-based proportion.
